(19) United States
(12) Patent Application Publication
(10) Pub. No.: US 2024/0429630 A1
(43) Pub. Date: Dec. 26, 2024

(54) CONDUCTOR CONNECTION TERMINAL

(71) Applicant: WAGO Verwaltungsgesellschaft mbH, Minden (DE)

(72) Inventors: Thomas WITTE, Porta Westfalica (DE); Tobias DYCK, Rahden (DE)

(73) Assignee: WAGO Verwaltungsgesellschaft mbH, Minden (DE)

(21) Appl. No.: 18/747,454

(22) Filed: Jun. 19, 2024

(30) Foreign Application Priority Data
Jun. 23, 2023 (DE) 20 2023 103 488.8

(51) Int. Cl. H01R 4/48

(52) U.S. Cl. CPC H01R 4/4828; H01R 4/483; H01R 4/489

(57) ABSTRACT

A conductor connection terminal with a spring-loaded terminal connection for connecting an electrical conductor. The spring-loaded terminal connection has a clamping spring and an actuating mechanism for displacing at least one part of the clamping spring between an open position and a closed position.

This nonprovisional application claims priority under 35 U.S.C. § 119 (a) to German Patent Application No. 20 2023 103 488.8, which was filed in Germany on Jun. 23, 2023, and which is herein incorporated by reference.

### BACKGROUND OF THE INVENTION

### Field of the Invention

The invention relates to a conductor connection terminal with a spring-loaded terminal connection for connecting an electrical conductor, wherein the spring-loaded terminal connection has a clamping spring and an actuating mechanism for displacing at least one part of the clamping spring between an open position and a closed position.

### Description of the Background Art

Conductor connection terminals are known in which the actuating mechanism has an actuating lever and a spring actuator that can be coupled to the actuating lever by a transmission mechanism, in particular a gear unit. An actuating force acting on the actuating lever can be transmitted by the transmission mechanism to the spring actuator that displaces at least one part of the clamping spring.

### SUMMARY OF THE INVENTION

It is therefore an object of the invention is to provide an improved conductor connection terminal.

It is proposed in an example, that, in a conductor connection terminal the actuating mechanism is configured to displace at least one part of the clamping spring a part of the distance from the closed position to the open position by a first lever motion of the actuating lever, and to displace the at least one part of the clamping spring another part of the distance toward the open position by a second lever motion, wherein a maximum actuating travel of the actuating lever is associated in each case with a part of the distance. In this way, the actuating force required for displacing at least one part of the clamping spring can be reduced. Moreover, large spring forces can be achievable with small actuating forces. In other words, the actuating lever can be moved back and forth more than once between its closing position and its opening position in order to transfer the clamping spring from the closed position to the open position. The number of lever motions is not limited, in principle, to two lever motions, but instead can also include more than two lever motions, for example three, four, or five lever motions, depending on the design of the conductor connection terminal. Owing to the repeated lever motion, the actuating force required for actuating the actuating lever for each lever motion can be reduced. The at least one part of the clamping spring can thus be displaced in steps from the closed position to the open position. Owing to the actuation divided into multiple lever motions, any desired opening angles of the clamping spring can be selectable. The proposed conductor connection terminal can be actuated with a reduced actuating force and nevertheless has a small size.

The actuating lever can be actuated through a mechanically limited actuating travel, namely from a closing position into an opening position and vice versa. In contrast to conductor connection terminals according to the prior art, however, this maximum actuating travel of the actuating lever is not associated with the full distance provided by design for the at least one part of the clamping spring to be displaced, which is to say the distance from the closed position to the open position, but instead only a part of the distance from the closed position to the open position in each case. In order for the part of the clamping spring to be displaced to travel the desired distance from the closed position to the open position, therefore, more than one full actuation of the actuating lever from the closing position to the opening position is necessary in the conductor connection terminal according to the invention.

The open position in the spring-loaded terminal connection serves the purpose that an electrical conductor can be arranged at the clamping point or can be removed again from the conductor connection terminal without application of force. In the closed position, the electrical conductor is clamped in place at a clamping point via the clamping spring.

The clamping spring can, for example, have a clamping leg and a support leg that are joined to one another by a spring bend. With the support leg, the clamping spring can brace itself on a component structure of the conductor connection terminal. The clamping leg can be configured to clamp an electrical conductor inserted into the conductor connection terminal against a bus bar. Via the actuating mechanism, at least a part of the clamping spring, in particular the clamping leg or a part of the clamping leg, can be displaced between an open position, in which the electrical conductor can be inserted into the conductor connection terminal, and a closed position, in which the electrical conductor is clamped. In the open position, the clamping leg can be arranged apart from the bus bar in this case. In the closed position, the conductor can rest on the bus bar, in which case the conductor can be clamped against the bus bar by the clamping leg.

The actuating mechanism of the conductor connection terminal can be designed as multiple parts with the actuating lever and the spring actuator that can be coupled to the actuating lever, wherein a transmission of force between the actuating lever and the spring actuator can take place during a coupling. The spring actuator can be coupled to the actuating lever, in particular at times, for example the actuating lever and the spring actuator can be coupled to one another in a force-transmitting manner during a first and a second lever motion and be decoupled from one another during a lever return occurring between the first and second lever motions, for example by a freewheel. In this way, it is possible to prevent the part of the clamping spring that is displaced during the first lever motion from being displaced back by the lever return.

The transmission mechanism can have a gear unit, for example, wherein a transmission ratio, in particular a transmission ratio differing from a transmission ratio 1:1, can be provided between the actuating lever and the spring actuator. In particular, a speed reduction can take place starting from the actuating lever to the spring actuator in order to achieve a precise clamping spring displacement with low actuating force.

The actuating mechanism can have a mechanical return stop for blocking a return motion of the spring actuator. In this way, it is possible to prevent the spring actuator and the part of the clamping spring that is displaced during the first lever motion from being displaced back by the spring force of the clamping spring during the lever return between the first lever motion and the second lever motion.

The mechanical return stop can, for example, have a wraparound spring that is configured to block a return motion of the spring actuator. A reliable and simple locking action in a first direction of motion of the spring actuator as well as a freewheel in a second direction of motion of the spring actuator can be achieved with a wraparound spring.

The return stop can have a pawl that is configured to block a return motion of the spring actuator. A reliable and simple locking action in a first direction of motion of the spring actuator as well as a freewheel in a second direction of motion of the spring actuator can be achieved with a pawl. The pawl can, for example, engage the spring actuator by friction or an interlock, and block a motion of the spring actuator in the first direction of motion. The pawl can be spring-mounted in order to improve the locking action.

The return stop can be deactivated by a release mechanism. In this way, the return of the spring actuator is facilitated, for example in order to displace the at least one part of the clamping spring from the open position to the closed position. The blocking of the spring actuator by the return stop can be terminated via the release mechanism. As a result, after deactivation of the return stop, the clamping leg, for example, can pivot back into the closed position and clamp the conductor in place.

For example, the release mechanism can have a manual release operating element, via whose actuation the return stop can be deactivated. In this way, an active return of the spring actuator that can be directly controlled by a user is possible. The release operating element can be a pushbutton, for example.

The release mechanism can have an automatic release element, via which the return stop can be automatically deactivated. In this way, an automatic return of the spring actuator is possible for which no additional, direct manual action by a user is necessary. For example, the automatic release element can deactivate the return stop while an electrical conductor is being inserted into the conductor connection terminal. Such an automatic triggering by an inserted conductor can also be referred to as a snap-in release mechanism. The conductor can, for example, disengage a pawl of the return stop from engagement with the spring actuator, for instance through direct mechanical contact or through an indirect snap-in trigger such as, e.g., a rocker.

The transmission mechanism can have toothing on the actuating lever and/or on the spring actuator. In this way, the transmission mechanism can be designed to be simple and reliable. The actuating lever and the spring actuator can each have teeth that can mesh to couple the actuating lever with the spring actuator and permit a transmission of force between the actuating lever and the spring actuator. For example, the actuating lever and the spring actuator can have external toothing on their outer contours at least in sections. In principle, configurations are also possible in which the actuating lever has external toothing on its outer contour and the spring actuator has internal toothing on an inner contour of the spring actuator, or vice versa.

The toothing can be a sawtooth profile. In this way, the coupling and decoupling of the actuating lever with and from the spring actuator can be improved. A sawtooth profile has teeth with alternating shallowly rising flanks and steeply dropping flanks. In a first direction of motion of the teeth relative to one another, the steep flanks rest against one another so that a coupling and transmission of force occurs between the actuating lever and the spring actuator. In a second direction of motion of the teeth relative to one another, the shallow flanks slip on one another so that the actuating lever can disengage from the engagement with the spring actuator, and decoupling takes place.

The number of teeth can be made variable so that a finer adjustment of the clamping spring can take place with an increased number of teeth or tooth pairings.

The transmission mechanism can have a self-locking gear unit. In this way, a precise and controlled actuation of the actuating lever and of the spring actuator can take place. The self-locking gear unit can be implemented as a worm drive, for example.

The actuating lever can be spring-mounted. A defined decoupling and the return of the actuating lever from the spring actuator can be assisted in this way. For example, the actuating lever can be actuated against the spring force of the spring mount and be coupled to the spring actuator via an actuating force acting on the actuating lever, while the actuating lever is returned in the direction of the opening position by the spring force upon cessation of the actuating force.

The actuating lever can be mounted so as to be pivotable about a rotational axis. In this way, a compact actuating mechanism can be provided. The actuating lever can be designed as a pivoting lever. The actuating lever can execute primarily a rotational motion upon actuation. Optionally, the actuating lever can be supported in a floating manner in order to permit a limited additional translational motion of the actuating lever toward the spring actuator, for example in order to facilitate the coupling and decoupling of the actuating lever with and from the spring actuator.

The spring actuator can be mounted so as to be pivotable about a rotational axis. In this way, a compact actuating mechanism can be provided. The spring actuator can be designed as a pivoting actuator. The spring actuator can execute primarily a rotational motion during actuation. Optionally, the spring actuator can be supported in a floating manner in order to permit a limited additional translational mobility.

The transmission mechanism can have a gear train. In this way, the transmission mechanism can be designed to be simple, compact, and reliable in operation. The actuating lever and the spring actuator can be mounted so as to be pivotable about a rotational axis in this case. The actuating lever and the spring actuator can each form a gear contour, at least in sections. For example, the actuating lever and the spring actuator can each have external toothing on a curved outer contour section or on a circular outer contour or also, for example, an internal or external toothing on a curved inner or outer contour section or on a circular inner or outer contour.

The spring actuator can be designed as an eccentric and have an actuating cam. In this way, the displacement of at least one part of the clamping spring can be controlled in a manner defined by the spring actuator. In the case of a spring actuator designed as an eccentric, a geometric center point of the spring actuator can be located outside the rotational axis of the spring actuator. Different opening characteristics and characteristic curves of the actuating and spring forces can be implemented through suitable design of the cam geometry or actuating contour of the actuating cam. For example, a linearized characteristic curve of the actuating force over the course of actuation can be realized. For example, a reduced opening speed can be implemented for large opening angles of the clamping spring. An opening angle of the clamping spring can refer to an instantaneous angle between the clamping leg in its position displaced toward the open position by the spring actuator and its closed position. During the displacement of the clamping leg into the open position, the opening angle becomes increasingly larger. In the case of large opening angles, for example after the clamping spring has been displaced by an additional distance via an additional, for example a second or third, lever motion, a reduced opening speed can be achievable via the correspondingly contoured actuating cam.

The spring actuator can be mounted so as to be translationally movable. In this way, a direct-acting and efficient displacement of the at least one part of the clamping spring can take place. The spring actuator can follow a straight motion path during the actuation.

The transmission mechanism can have a rack-and-pinion gear. In this case, the actuating lever can, for example, be mounted so as to be pivotable about a rotational axis and have a curved gear contour, while the spring actuator can be translationally movable and has a straight gear rack contour, or vice versa. In this way, a rotational motion of the actuating lever can be converted into a translational motion of the spring actuator, or a translational motion of the actuating lever can be converted into a rotational motion of the spring actuator. In this way, a compact transmission mechanism can be combined with a direct-acting and efficient actuation.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein the sole FIGURE shows an exemplary conductor connection terminal.

### DETAILED DESCRIPTION

The FIGURE schematically shows a conductor connection terminal 1 with a spring-loaded terminal connection 2 for connecting an electrical conductor that is not depicted. The spring-loaded terminal connection 2 has a clamping spring 3 with a support leg 17 for bracing the clamping spring 3, and a clamping leg 8 for clamping an electrical conductor inserted into the spring-loaded terminal connection 2 against a bus bar 18. The spring-loaded terminal connection 2 additionally has an actuating mechanism 4 for displacing at least one part of the clamping spring 3, here the clamping leg 8, between an open position and a closed position. The actuating mechanism 4 has an actuating lever 5 and a spring actuator 7. The spring actuator 7 can be coupled to the actuating lever 5 by a transmission mechanism 6 that, in this example, can be designed as a gear unit. An actuating force acting on the actuating lever 5 can be transmitted by the transmission mechanism 6 to the spring actuator 7 in order to displace the clamping leg 8 of the clamping spring 3.

The actuating mechanism 4 can be configured to displace the clamping leg 8 a part s₁ of the distance s from the closed position to the open position via a first lever motion of the actuating lever 5, and to displace the clamping leg 8 another part s₂ of the distance s toward the open position via a second lever motion. The actuating force required to displace the clamping leg 8 can be reduced via the repeated lever motion.

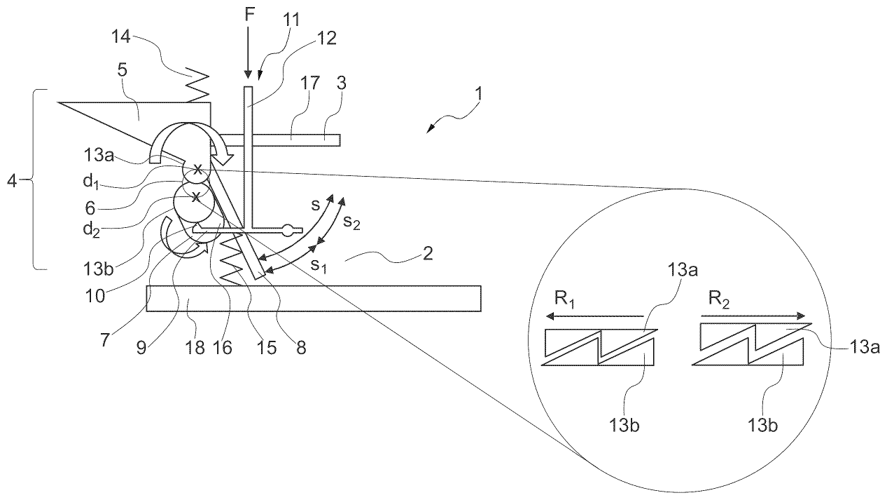

During the first lever motion and the second lever motion, the actuating lever 5 and the spring actuator 7 are coupled to one another by the transmission mechanism 6. During a lever return taking place between the first and second lever motions, the actuating lever 5 and the spring actuator 7 are decoupled from one another. For this purpose, the actuating lever 5 and the spring actuator 7 each have toothing 13a, 13b designed as a sawtooth profile that can mesh together to couple the actuating lever 5 to the spring actuator 7 and permit a transmission of force between the actuating lever 5 and the spring actuator 7. In a first direction of motion R1 of the sawteeth relative to one another, they can brace against one another at their steeply falling flanks and transmit an actuating force. In a second direction of motion R2 of the sawteeth relative to one another, they can slip on one another at their shallowly rising flanks, and thus permit a decoupling of the spring actuator 7 from the actuating lever 5. According to FIG. 1, the actuating lever 5 has a spring mount 14 in order to permit a defined decoupling and an improved return of the actuating lever 5.

According to FIG. 1, the actuating mechanism 4 has a mechanical return stop 9 for blocking a return motion of the spring actuator 7 in order to prevent the spring actuator 7 and the clamping leg 8 that is displaced during the first lever motion from being displaced back during the lever return. For this purpose, the return stop 9 has a pawl 10 that is provided with a spring mount 15 and that engages with the toothing 13b of the spring actuator 7 and in this way can block a return motion of the spring actuator 7.

The return stop can be deactivated by a release mechanism 11 in order to facilitate a desired return of the spring actuator 7 and to permit a return displacement of the clamping leg 8 from the open position to the closed position. The blocking of the spring actuator 7 by the pawl 10 can be terminated via the release mechanism 11. For this purpose, the release mechanism 11 has a manual release operating element 12 designed as a pushbutton, via whose actuation through a manual releasing force F the return stop 9 can be deactivated.

According to the example shown, the transmission mechanism 6 has a gear train in order to provide a compact actuating mechanism. The actuating lever 5 in this case is mounted so as to be pivotable about a rotational axis d₁ and has, in sections, a gear contour with the above-described sawtooth profile as external toothing. The spring actuator 7 is pivotable about a rotational axis d₂ and has, in sections, a gear contour with the above-described sawtooth profile as external toothing that can engage with the gear contour of the actuating lever 5.

It can be seen in the FIGURE that the spring actuator 7 is designed as an eccentric and has an actuating cam 16 in order to control the displacement of the clamping leg 8 in a manner defined according to a desired characteristic curve.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
a spring-loaded terminal connection to connect an electrical conductor, the spring-loaded terminal connection comprising a clamping spring and an actuator to displace at least one part of the clamping spring between an open position and a closed position,
an actuating lever and a spring actuator provided for the actuator, the spring actuator being adapted to be coupled to the actuating lever by a transmission or a gear unit of the transmission,
wherein the actuator is configured to displace at least one part of the clamping spring a part of the distance from the closed position to the open position by a first lever motion of the actuating lever, and to displace the at least one part of the clamping spring another part of the distance toward the open position by a second lever motion, and
wherein a maximum actuating travel of the actuating lever is associated in each case with a part of the distance.

2. The conductor connection terminal according to claim 1, wherein the actuator has a mechanical return stop to block a return motion of the spring actuator.

3. The conductor connection terminal according to claim 2, wherein the return stop has a wraparound spring that is configured to block a return motion of the spring actuator.

4. The conductor connection terminal according to claim 2, wherein the return stop has a pawl that is configured to block a return motion of the spring actuator.

5. The conductor connection terminal according to claim 2, wherein the return stop is adapted to be deactivated by a release.

6. The conductor connection terminal according to claim 5, wherein the release has a manual release operating element, via whose actuation the return stop is deactivated.

7. The conductor connection terminal according to claim 5, wherein the release has an automatic release element, via which the return stop is automatically deactivated.

8. The conductor connection terminal according to claim 1, wherein the transmission has toothing on the actuating lever and on the spring actuator.

9. The conductor connection terminal according to claim 8, wherein the toothing is a sawtooth profile.

10. The conductor connection terminal according to claim 1, wherein the transmission has a self-locking gear unit.

11. The conductor connection terminal according to claim 1, wherein the actuating lever is spring-mounted.

12. The conductor connection terminal according to claim 1, wherein the actuating lever is mounted so as to be pivotable about a rotational axis.

13. The conductor connection terminal according to claim 1, wherein the spring actuator is mounted so as to be pivotable about a rotational axis.

14. The conductor connection terminal according to claim 1, wherein the transmission mechanism has a gear train.

15. The conductor connection terminal according to claim 1, wherein the spring actuator is designed as an eccentric and has an actuating cam.

16. The conductor connection terminal according to claim 1, wherein the spring actuator is mounted so as to be translationally movable.

17. The conductor connection terminal according to claim 1, wherein the transmission has a rack-and-pinion gear.
